(19) United States
(12) Patent Application Publication
(10) Pub. No.: US 2017/0191458 A1
(43) Pub. Date: Jul. 6, 2017

(54) VEHICLE CONTROL APPARATUS

(71) Applicant: TOYOTA JIDOSHA KABUSHIKI KAISHA, Toyota-shi (JP)

(72) Inventors: Junichi MORIMURA, Sunton-gun (JP); Yu SAKAI, Toyota-shi (JP); Fumichika SHIMOSE, Toyota-shi (JP)

(73) Assignee: TOYOTA JIDOSHA KABUSHIKI KAISHA, Toyota-shi (JP)

(21) Appl. No.: 15/316,752

(22) PCT Filed: Jun. 8, 2015
(86) PCT No.: PCT/IB2015/000863

§ 371 Date: Dec. 6, 2016

(30) Foreign Application Priority Data
Jun. 11, 2014 (JP) 2014-120865

(51) Int. Cl. F02N 11/08; B60W 10/06; B60T 13/66; F02D 41/14; B60T 17/22; F02D 41/22; F02D 41/04; B60T 13/52; B60T 13/68

(52) U.S. Cl. CPC F02N 11/084; B60T 13/52; B60W 10/06; B60T 13/662; B60T 13/686; B60T 17/221; F02D 41/222; F02N 11/0825; F02D 41/04; F02D 41/1401; B60T 17/22; F02N 2200/022; F02N 2200/0807

(57) ABSTRACT

A vehicle control apparatus includes at least one electronic control unit (50). The electronic control unit detects a negative pressure that is generated in a negative pressure chamber (34) of a braking operation support device (32). The electronic control unit prohibits, based on the detected negative pressure of the negative pressure chamber, an internal combustion engine (26) from automatically stopping when determining that a driver does not perform the braking operation and that a speed of the internal combustion engine is at a threshold or higher continuously for a specified time period or longer. The negative pressure is generated in the negative pressure chamber in response to rotation of the internal combustion engine. The braking operation support device supports, with the negative pressure in the negative pressure chamber, the driver to perform the braking operation.

### BACKGROUND OF THE INVENTION

1. Field of the Invention

The invention relates to a vehicle control apparatus. In particular, the invention relates to a vehicle control apparatus that automatically stops the internal combustion engine, and that automatically starts the internal combustion engine after the automatic stop of the internal combustion engine.

2. Description of Related Art

Conventionally, a vehicle control apparatus that prohibits automatic stop of an internal combustion engine during a malfunction of a negative pressure sensor has been known (for example, see Japanese Patent Application Publication No. 2011-122519 (JP 2011-122519 A)). A vehicle in which such a control apparatus is mounted has a brake booster that uses negative pressure of a negative pressure chamber generated in response to rotation of the internal combustion engine, so as to support a braking operation by a driver. In addition, in this vehicle, the internal combustion engine is automatically stopped in the case where a specified stop condition is satisfied, and the internal combustion engine is automatically started after the automatic stop in the case where a specified restart condition is satisfied.

The above control apparatus includes the negative pressure sensor that outputs a signal corresponding to the negative pressure of the negative pressure chamber, and detects the negative pressure of the negative pressure chamber on the basis of the output signal of the negative pressure sensor. Then, on the basis of a result of the negative pressure detection, the control apparatus determines whether a malfunction of the negative pressure sensor occurs. More specifically, if the output signal of the negative pressure sensor falls out of a desired normal range continuously for a specified time period or longer, the control apparatus determines that the malfunction of the negative pressure sensor has occurred. As a result, if it is determined that the malfunction of the negative pressure sensor has occurred, the control apparatus prohibits the automatic stop of the internal combustion engine and automatically starts the internal combustion engine.

By the way, while the negative pressure sensor outputs a signal that changes in accordance with the negative pressure, the malfunction of the negative pressure sensor occurs, and the malfunction includes malfunctions due to deviations (hereinafter referred to as “deviation-malfunction”), such as a gain deviation and an offset deviation, caused by a temperature characteristic, a change by aging, or the like. Meanwhile, the control apparatus that is described in the above JP 2011-122519 A cannot determine the occurrence of a malfunction unless the output signal of the negative pressure sensor falls out of the desired normal range. Thus, when the gain deviation or the offset deviation is relatively small enough for the output signal of the negative pressure sensor to fall within the desired normal range, the malfunction of the negative pressure sensor cannot be detected. For this reason, even when the deviation-malfunction occurs in the negative pressure sensor, there is a case where the deviation-malfunction cannot be detected as the malfunction of the negative pressure sensor. As a result, the automatic stop of the internal combustion engine possibly remains permitted.

### SUMMARY OF THE INVENTION

The invention provides a vehicle control apparatus that can suppress unnecessary automatic stop of an internal combustion engine.

A vehicle control apparatus according to an aspect of the invention includes at least one electronic control unit. The electronic control unit is configured to:
(i) automatically stop an internal combustion engine when a first condition is satisfied;
(ii) automatically start the internal combustion engine when a second condition is satisfied after the internal combustion engine is automatically stopped;
(iii) determine whether a driver performs a braking operation;
(iv) detect a speed of the internal combustion engine;
(v) detect a negative pressure that is generated in a negative pressure chamber of a braking operation support device; and
(vi) prohibit, based on the detected negative pressure of the negative pressure chamber, the internal combustion engine from automatically stopping when the electronic control unit determines that the driver does not perform the braking operation and that the detected speed of the internal combustion engine is at a threshold or higher continuously for a specified time period or longer.
   The negative pressure is generated in the negative pressure chamber in response to rotation of the internal combustion engine. The braking operation support device is configured to support, with the negative pressure in the negative pressure chamber, the driver to perform the braking operation.

According to the aspect of the invention, the unnecessary automatic stop of the internal combustion engine can be suppressed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration diagram of a vehicle and a control apparatus thereof that are an embodiment of the invention;

FIG. 2 is a configuration diagram of hardware of a brake system that is mounted in the vehicle in the embodiment;

FIG. 3 is a time chart corresponding to an example of an operation executed by the vehicle control apparatus of the embodiment;

FIG. 4 is an example of a flowchart of a control routine that is executed in the vehicle control apparatus of the embodiment;

FIG. 5 is a graph of a relationship between a speed NE of an internal combustion engine and a specified time period T1, the graph being used in a vehicle control apparatus as a modification of the invention;

FIG. 6 is a time chart corresponding to an example of an operation executed by the vehicle control apparatus as the modification of the invention;

a combination of FIGS. 7A and 7B is an example of a flowchart of a control routine that is executed in the vehicle control apparatus as the modification shown in FIG. 6;

FIG. 8 is an example of a flowchart of a control routine that is executed in the vehicle control apparatus as the modification of the invention;

FIG. 9 is an example of a flowchart of a control routine that is executed to set a negative pressure determination threshold in the vehicle control apparatus as the modification of the invention;

FIG. 10 is an example of a flowchart of a control routine that is executed to calculate atmospheric pressure in the vehicle control apparatus as the modification shown in FIG. 9;

FIGS. 11A to 11C are maps that are used when the atmospheric pressure is calculated in the vehicle control apparatus as the modification shown in FIG. 9;

FIG. 12 is an example of a flowchart of a control routine that is executed to calculate required negative pressure in the vehicle control apparatus as the modification shown in FIG. 9; and

FIGS. 13A and 13B are maps that are used when the required negative pressure is calculated in the vehicle control apparatus as the modification shown in FIG. 9.

### DETAILED DESCRIPTION OF EMBODIMENTS

A description will hereinafter be made on a specific embodiment of a vehicle control apparatus according to the invention with the drawings.

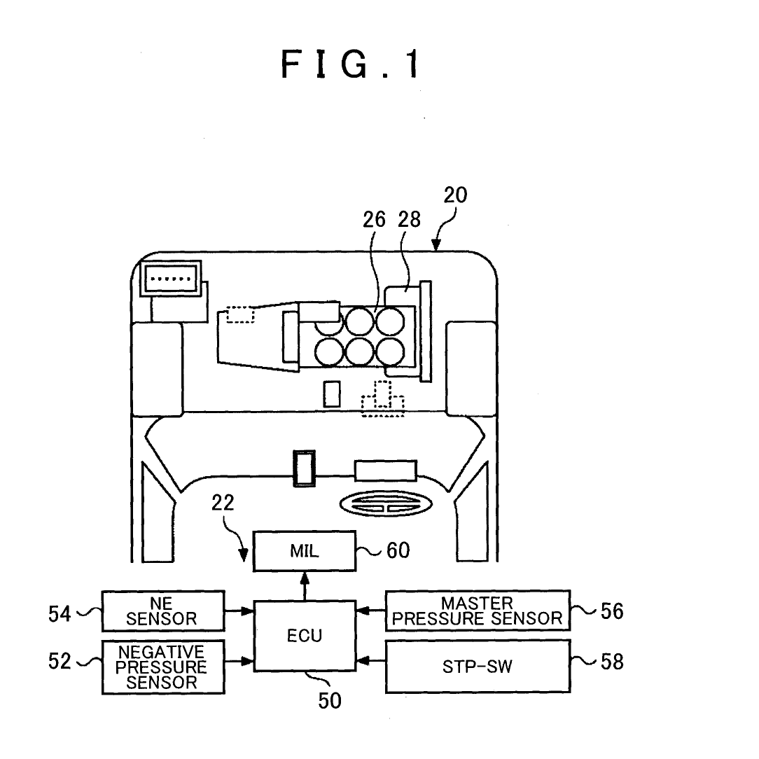

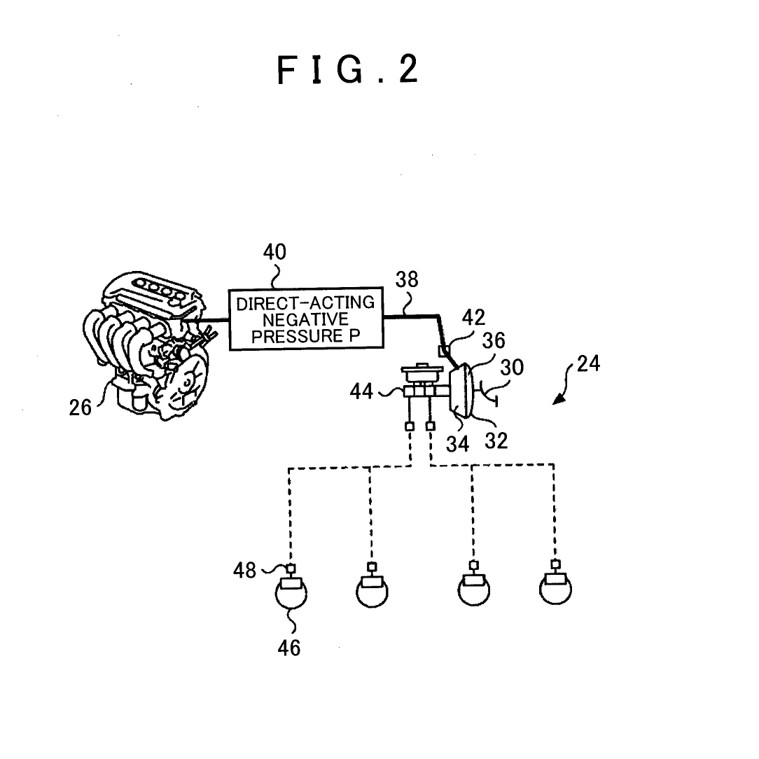

FIG. 1 is a configuration diagram of a vehicle 20 and a control apparatus 22 thereof that are an embodiment of the invention. In addition, FIG. 2 is a configuration diagram of hardware of a brake system 24 that is mounted in the vehicle 20 in the embodiment.

As shown in FIG. 1 and FIG. 2, the vehicle 20 has the brake system 24 and an internal combustion engine 26. The internal combustion engine 26 is a heat engine that obtains vehicle power by exploding and combusting fuel. The internal combustion engine 26 may be a gasoline engine or a diesel engine. The internal combustion engine 26 can be started by a starter 28 that is driven by an electric power supply from a built-in battery.

The brake system 24 has a brake pedal 30 and a brake booster 32. The brake pedal 30 is operated by a driver of the vehicle 20. The brake pedal 30 is also a pedal on which the driver performs a brake pedal depressing operation by increasing a depression force or a depression amount when a braking force of the vehicle 20 is increased and on which the driver performs a brake pedal returning operation by reducing the depression force or the depression amount when the braking force of the vehicle 20 is reduced from a brake pedal depressing state. The brake booster 32 is coupled to the brake pedal 30.

The brake booster 32 has a negative pressure chamber 34 and a variable pressure chamber 36 therein that are partitioned by a diaphragm. A direct-acting negative pressure pump 40 is connected to the negative pressure chamber 34 via a negative pressure pipe 38. A check valve 42 is provided in a middle of the negative pressure pipe 38, and the check valve 42 is a one-way valve that only permits an air flow from the negative pressure chamber 34 side toward the direct-acting negative pressure pump 40 side. The check valve 42 is opened when pressure of the negative pressure pipe 38 on the negative pressure chamber 34 side is higher than that on the direct-acting negative pressure pump 40 side.

The direct-acting negative pressure pump 40 is a pump that is actuated in response to rotation of the internal combustion engine 26 and thereby introduces negative pressure that is lower than atmospheric pressure into the negative pressure pipe 38. In the following description, the negative pressure is a value that is defined with the atmospheric pressure as a reference. That “the negative pressure is high” means that the pressure is on a side close to zero [kPa] (vacuum pressure), that “the negative pressure is low” means that the pressure is on a side close to the atmospheric pressure, a “negative pressure increase” means that the pressure is shifted to the side close to zero, and a “negative pressure reduction” means that the pressure is shifted to the side close to the atmospheric pressure.

The direct-acting negative pressure pump 40 is connected to a cam of the internal combustion engine 26 and rotates at half a speed of the internal combustion engine 26, so as to introduce the negative pressure into the negative pressure pipe 38. The negative pressure that is introduced into the negative pressure pipe 38 is supplied to the negative pressure chamber 34. In the negative pressure chamber 34, the negative pressure that corresponds to the speed of the internal combustion engine 26 is generated. The direct-acting negative pressure pump 40 can generate the negative pressure of a specified level or higher (specifically, in the vicinity of zero [kPa]) in the negative pressure chamber 34 when the speed of the internal combustion engine 26 is at a specified speed or higher continuously for a specified time period or longer.

When the depressing operation of the brake pedal 30 is not performed, the negative pressure of the negative pressure chamber 34 is introduced into the variable pressure chamber 36 of the brake booster 32. In this case, differential pressure is hardly generated between the variable pressure chamber 36 and the negative pressure chamber 34. Meanwhile, when the depressing operation of the brake pedal 30 is performed, atmospheric air is introduced into the variable pressure chamber 36 in response to the brake pedal depression force on the brake pedal 30. In this case, the differential pressure that corresponds to the brake pedal depression force is generated between the variable pressure chamber 36 and the negative pressure chamber 34. This differential pressure acts as an assisting force that has a specified boosting ratio with respect to the brake pedal depression force on the brake pedal 30. Accordingly, when the depressing operation of the brake pedal 30 is performed during the rotation of the internal combustion engine 26, the brake booster 32 generates, with the negative pressure of the negative pressure chamber 34, the assisting force that assists in application of the brake pedal depression force on the brake pedal 30 by the driver.

A master cylinder 44 that has a hydraulic chamber filled with brake oil is coupled to the brake booster 32. Master cylinder pressure that corresponds to a resultant force of the brake pedal depression force and the assisting force of the brake booster 32 is generated in the hydraulic chamber of the master cylinder 44. A wheel cylinder 48 that is provided for each wheel 46 is connected to the master cylinder 44. Each of the wheel cylinders 48 applies the braking force that corresponds to the master cylinder pressure of the master cylinder 44 to the wheel 46.

The control apparatus 22 that is mounted in the vehicle 20 includes an electronic control unit (ECU) 50 that is constructed of a microcomputer as a main component. An actuator, a starter 28, and the like for an injector, a fuel pump, and the like for fuel injection that are provided in the internal combustion engine 26 are electrically connected to the ECU 50. The ECU 50 controls driving of each of the actuators, driving of the starter 28, and the like of the internal combustion engine 26.

In addition, the ECU 50 can execute control that automatically stops the internal combustion engine 26 in the case where a specified stop condition is satisfied and that automatically starts (restarts) the internal combustion engine 26 after the automatic stop of the internal combustion engine 26 in the case where a specified restart condition is satisfied. This control will hereinafter be referred to as stop & start (S & S) control. That is, the vehicle 20 is an idle stop vehicle that executes the S & S control. Fuel efficiency of the vehicle 20 can be improved by the S & S control.

The specified stop condition in the S & S control is a deceleration of the vehicle that includes a case where, after the internal combustion engine 26 is started and the vehicle 20 starts running, the brake pedal depressing operation, in which the driver depresses the brake pedal 30, is performed (for example, it may include a case where a vehicle speed is reduced to a specified vehicle speed or lower and a case where a deceleration rate of the vehicle becomes a specified deceleration rate or higher). In addition, the specified restart condition includes a case where, after the execution of the S & S control starts, the above brake pedal returning operation is performed or an accelerating operation is performed, a case where an in-vehicle electric load becomes a specified load or larger, and the like.

The control apparatus 22 also includes a negative pressure sensor 52 that is connected to the ECU 50. The negative pressure sensor 52 is disposed in the negative pressure chamber 34 of the brake booster 32. The negative pressure sensor 52 outputs a signal corresponding to the negative pressure (the pressure) generated in the negative pressure chamber 34. The negative pressure sensor 52 is a sensor for monitoring the negative pressure of the negative pressure chamber 34 in the brake booster 32 during the automatic stop of the internal combustion engine 26 by the S & S control.

The output signal of the negative pressure sensor 52 is supplied to the ECU 50. The ECU 50 detects negative pressure Pvac of the negative pressure chamber 34 on the basis of the output signal of the negative pressure sensor 52. Then, the ECU 50 uses the detected negative pressure Pvac of the negative pressure chamber 34 for control such as the driving of each of the actuators in the internal combustion engine 26. In addition, in the case where the detected negative pressure Pvac that is at specified negative pressure or higher is not secured during the automatic stop of the internal combustion engine 26 by the S & S control, the ECU 50 executes processing for automatically starting the internal combustion engine 26 by canceling the automatic stop, so as to secure the negative pressure of the negative pressure chamber 34.

A speed sensor 54 is connected to the ECU 50. The speed sensor 54 outputs a signal that corresponds to the speed of the internal combustion engine 26. The output signal of the speed sensor 54 is supplied to the ECU 50. The ECU 50 detects a speed NE of the internal combustion engine 26 on the basis of the output signal of the speed sensor 54. Then, the ECU 50 uses the detected speed NE of the internal combustion engine 26 for the control such as the driving of each of the actuators in the internal combustion engine 26.

A master pressure sensor 56 is connected to the ECU 50. The master pressure sensor 56 is disposed in the hydraulic chamber of the master cylinder 44. The master pressure sensor 56 outputs a signal corresponding to the pressure generated in the hydraulic chamber of the master cylinder 44. The output signal of the master pressure sensor 56 is supplied to the ECU 50. The ECU 50 detects pressure (hereinafter referred to as master pressure) Pm of the hydraulic chamber of the master cylinder 44 on the basis of the output signal of the master pressure sensor 56.

A stop lamp switch 58 is connected to the ECU 50. The stop lamp switch 58 is a switch that is turned on or off in response to the braking operation on the brake pedal 30 by the driver. The stop lamp switch 58 is turned on when the depressing operation of the brake pedal 30 is performed from a cancelled state, and the stop lamp switch 58 is turned off when the depressing operation of the brake pedal 30 is cancelled. The ECU 50 detects a state of the stop lamp switch 58.

An indication lamp (malfunction indication lamp (MIL)) 60 that is provided in a visually recognizable meter by the driver is connected to the ECU 50. On the basis of the negative pressure Pvac of the negative pressure chamber 34, which is detected as described above, the ECU 50 determines whether the negative pressure sensor 52 is in a malfunction condition. The determination regarding the malfunction condition will be described in detail below. Noted that this malfunction condition includes deviation-malfunctions such as a gain deviation and an offset deviation. If the ECU 50 determines that the negative pressure sensor 52 is in the malfunction condition, the ECU 50 prohibits the automatic stop of the internal combustion engine 26 by the S & S control, stores a diagnosis that indicates a malfunction of the negative pressure sensor 52, turns on the MIL 60 in order to notify the driver of the malfunction of the negative pressure sensor 52 or prohibition of the automatic stop of the internal combustion engine 26.

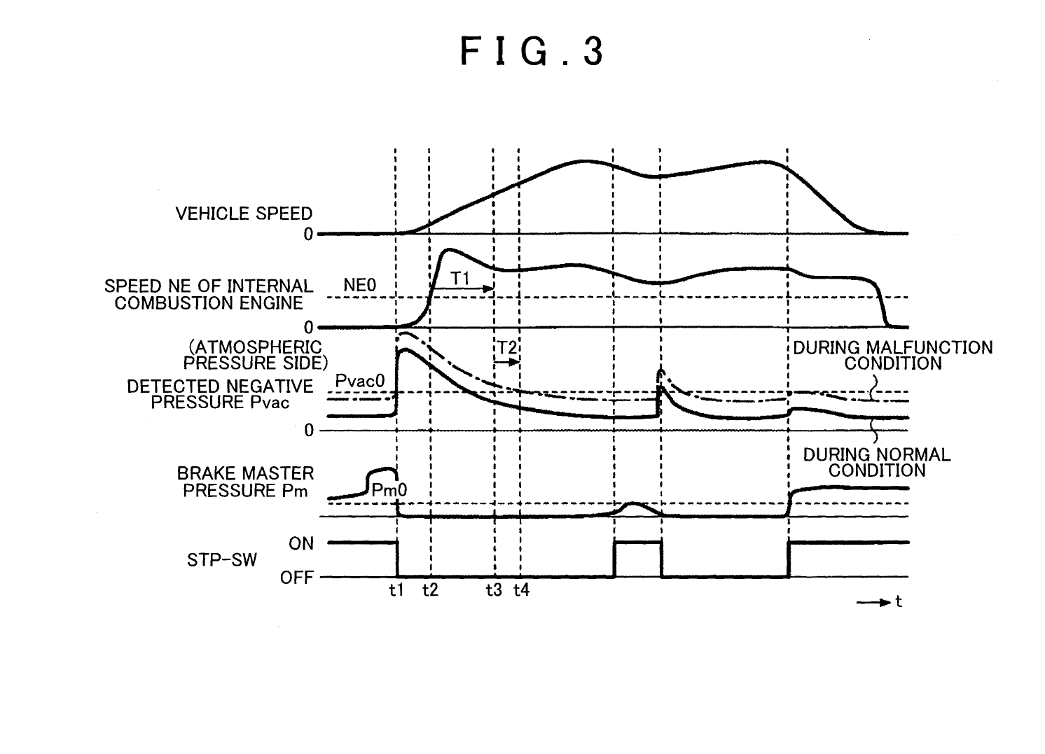

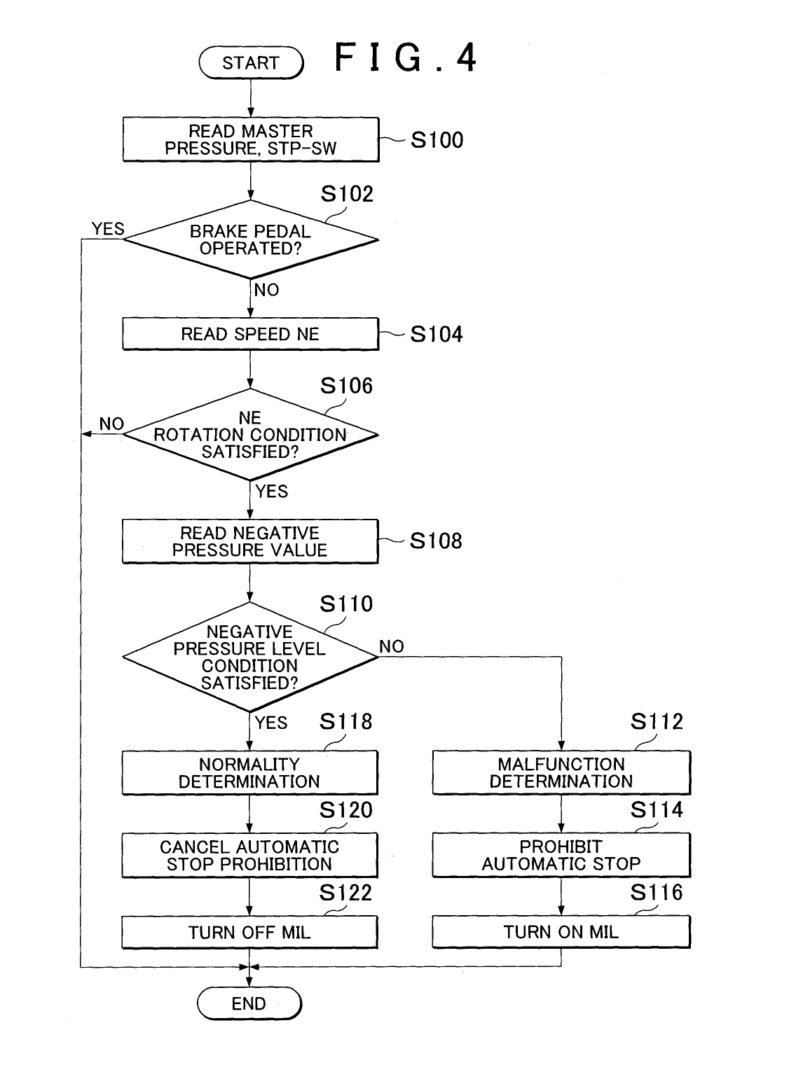

FIG. 3 is a time chart corresponding to an example of an operation executed by the control apparatus 22 of the vehicle 20 of the embodiment. In addition, FIG. 4 is an example of a flowchart of a control routine that is executed in the control apparatus 22 of the vehicle 20 of the embodiment in order to determine whether the negative pressure sensor 52 is in a malfunction condition.

In the brake system 24 of the embodiment, the depressing operation of the brake pedal 30 is performed, then the depressing operation of the brake pedal 30 is canceled, and the brake pedal returning operation is performed (at time t1 in FIG. 3). In this case, the atmospheric air is introduced into the negative pressure chamber 34 of the brake booster 32, and the negative pressure of the negative pressure chamber 34 is thereby abruptly reduced to the atmospheric pressure side. In addition, when the brake pedal returning operation of the brake pedal 30 is performed during the automatic stop of the internal combustion engine 26 by the S & S control (the time t1), the above specified restart condition is satisfied, and thus the internal combustion engine 26 is automatically started. Accordingly, the speed of the internal combustion engine 26 is increased in a delayed manner after the negative pressure of the negative pressure chamber 34 is reduced. When the internal combustion engine 26 rotates, the negative pressure of the negative pressure chamber 34 is gradually increased from the atmospheric pressure side toward zero [kPa] by the actuation of the direct-acting negative pressure pump 40 unless the braking operation on the brake pedal 30 is performed.

The ECU 50 in the control apparatus 22 of the embodiment eliminates timing at which the negative pressure of the negative pressure chamber 34 in the brake booster 32 is consumed for the braking operation on the brake pedal 30 from timing at which the ECU 50 determines whether the negative pressure sensor 52 is in the malfunction condition. More specifically, the ECU 50 first reads the master pressure Pm on the basis of the output signal of the master pressure sensor 56 or reads the state of the stop lamp switch 58 at predetermined time intervals (step S100).

After reading data in the above step S100, the ECU 50 determines whether the braking operation on the brake pedal 30 is performed by the driver (step S102). A negative determination may be made, for example, if the master pressure Pm is lower than a specified value Pm0 or if the stop lamp switch 58 is in an off state. The above specified value Pm0 may be set at a maximum value of the master pressure Pm that is generated when the braking operation on the brake pedal 30 is not performed.

If the ECU 50 determines in the above step S102 that the braking operation on the brake pedal 30 is being performed, any processing will not be performed from this time onward, and the current routine is terminated. On the other hand, if the ECU 50 determines that the braking operation on the brake pedal 30 is not being performed, the ECU 50 next reads the speed NE of the internal combustion engine 26 on the basis of the output signal of the speed sensor 54 (step S104).

After reading data in the above step S104, the ECU 50 determines whether a rotation condition of the internal combustion engine 26 is satisfied (step S106). A positive determination may be made, for example, if the speed NE of the internal combustion engine 26 is at a specified threshold NE0 or higher continuously for a specified time period T1 (time t2 to t3 in FIG. 3; for example, 5 seconds, 10 seconds, or the like) or longer from the beginning of the state where the speed NE is at the specified threshold NE0 or higher. Each of the specified threshold NE0 and the specified time period T1 may be set at a value at which it is determined that the negative pressure in the specified level or higher (specifically, in the vicinity of zero [kPa]) is generated in the negative pressure chamber 34 of the brake booster 32 by the actuation of the direct-acting negative pressure pump 40.

If the ECU 50 determines in the above step S106 that the rotation condition of the internal combustion engine 26 is not satisfied, any processing will not be performed from this time onward, and the current routine is terminated. On the other hand, if the ECU 50 determines that the rotation condition of the internal combustion engine 26 is satisfied, the ECU 50 next reads the negative pressure Pvac that is generated in the negative pressure chamber 34 of the brake booster 32 on the basis of the output signal of the negative pressure sensor 52 (step S108).

After reading data in the above step S108, the ECU 50 determines whether a negative pressure level condition of the negative pressure chamber 34 is satisfied (step S110). A positive determination may be made, for example, if the negative pressure Pvac of the negative pressure chamber 34 is at specified negative pressure Pvac0 or higher (that is, a value on the pressure zero [kPa] side with respect to the specified negative pressure Pvac0).

This specified negative pressure Pvac0 may be set at a minimum value of the negative pressure that can be obtained if the braking operation on the brake pedal 30 is not performed, the above rotation condition of the internal combustion engine 26 is satisfied, and the negative pressure sensor 52 is in the normal condition. In addition, a positive determination regarding the above negative pressure level may be satisfied if the negative pressure Pvac is at the specified negative pressure Pvac0 or higher continuously for a specified time period T2 (the time t3 to t4 in FIG. 3) or longer. In this case, the specified time period T2 is used to eliminate such an erroneous determination that the negative pressure sensor 52 is in the normal condition when the read negative pressure Pvac is at the specified negative pressure Pvac0 or higher due to noise or the like during the malfunction of the negative pressure sensor 52. Thus, the specified time period T2 may be set to a predetermined time period.

The ECU 50 determines in the above step S110 that the negative pressure level condition is not satisfied if the negative pressure Pvac is lower than the specified negative pressure Pvac0 and thus is on the atmospheric pressure side with respect to the specified negative pressure Pvac0. In this case, the ECU 50 determines that the negative pressure sensor 52 is in the malfunction condition (step S112). Noted that the malfunction includes a deviation malfunction in the negative pressure sensor 52.

In addition, if the ECU 50 determines in the above step S110 that the negative pressure level condition is not satisfied, the ECU 50 prohibits the automatic stop of the internal combustion engine 26 by the S & S control (step S114), stores the result of diagnosis that indicates the malfunction of the negative pressure sensor 52, and turns on the MIL 60 in order to notify the driver of the malfunction of the negative pressure sensor 52 or the prohibition of the automatic stop of the internal combustion engine 26 (step S116). The prohibition of the automatic stop of the internal combustion engine 26 based on the determination on the malfunction of the negative pressure sensor 52 includes the automatic start of the internal combustion engine 26 when it is determined that the negative pressure sensor 52 is in the malfunction condition during the automatic stop of the internal combustion engine 26.

On the other hand, the ECU 50 determines in the above step S110 that the negative pressure level condition is satisfied if the negative pressure Pvac is higher than the specified negative pressure Pvac0, i.e., the negative pressure Pvac is on the vacuum pressure side with respect to the specified negative pressure Pvac0. In this case, the ECU 50 determines that the negative pressure sensor 52 is in the normal condition (step S118). In addition, if the ECU 50 determines in the above step S110 that the negative pressure level condition is satisfied, the ECU 50 cancels the prohibition of the automatic stop of the internal combustion engine 26 by the S & S control (step S120) and turns off the MIL 60 in order to cancel the notification of the malfunction of the negative pressure sensor 52 or the prohibition of the automatic stop of the internal combustion engine 26 to the driver (step S122).

As described above, the control apparatus 22 of the vehicle 20 executing the S & S control of the embodiment can determine, on the basis of the negative pressure Pvac of the negative pressure chamber 34, whether the negative pressure sensor 52 is in the malfunction condition when no braking operation on the brake pedal 30 is performed and the speed NE of the internal combustion engine 26 is at the specified threshold NE0 or higher continuously for the specified time period T1 or longer. The negative pressure Pvac of the negative pressure chamber 34 is detected on the basis of the output signal of the negative pressure sensor 52.

At a timing when the braking operation on the brake pedal 30 is not performed, the speed NE of the internal combustion engine 26 is at the specified threshold NE0 or higher continuously for the specified time period T1 or longer, and the negative pressure sensor 52 is in the normal condition, the detected negative pressure Pvac of the negative pressure chamber 34 becomes the value on the pressure zero [kPa] side with respect to the specified negative pressure Pvac0. On the other hand, the negative pressure Pvac of the negative pressure chamber 34, which is detected with the negative pressure sensor 52 at the above timing, becomes the value on the atmospheric pressure side with respect to the specified negative pressure Pvac0 if the negative pressure sensor 52 is in the deviation-malfunction condition.

According to the control apparatus 22 of the embodiment, it is possible to determine whether the negative pressure sensor 52 is in the malfunction including the deviation-malfunction, by comparing the detected negative pressure Pvac of the negative pressure chamber 34 at the above timing with the specified negative pressure Pvac0. In addition, when the negative pressure sensor 52 is in the deviation-malfunction, this deviation-malfunction can promptly be detected as the malfunction of the negative pressure sensor 52. Therefore, according to the embodiment, the malfunction of the negative pressure sensor 52 can be determined further accurately by also detecting the deviation-malfunction.

In the embodiment, if the negative pressure Pvac of the negative pressure chamber 34, which is detected with the negative pressure sensor 52 at the above timing, becomes the value on the atmospheric pressure side with respect to the specified negative pressure Pvac0, or if it is determined that the negative pressure sensor 52 is in the malfunction condition, the automatic stop of the internal combustion engine 26 by the S & S control is prohibited from this time onward. Thus, according to the embodiment, it is possible to suppress the automatic stop of the internal combustion engine 26 by the S & S control at unnecessary timing during the malfunction condition of the negative pressure sensor 52. Alternatively, it is possible to suppress unnecessary continuation of the automatic stop of the internal combustion engine 26. Therefore, it is possible to prevent a tendency of the negative pressure of the negative pressure chamber 34 to be reduced due to the automatic stop of the internal combustion engine 26 when the negative pressure sensor 52 is in the malfunction condition.

In addition, in the embodiment, if it is determined that the negative pressure sensor 52 is in the malfunction condition as described above, the diagnosis that indicates the malfunction of the negative pressure sensor 52 is stored. Therefore, according to the embodiment, after the occurrence of the malfunction of the negative pressure sensor 52, a position where the malfunction has occurred in the vehicle 20 can easily be identified at a vehicle dealer or the like.

Furthermore, in the embodiment, if it is determined that the negative pressure sensor 52 is in the malfunction condition or the automatic stop of the internal combustion engine 26 by the S & S control is prohibited as described above, the MIL 60 is lit in order to notify the driver of the malfunction of the negative pressure sensor 52 or the prohibition of the automatic stop of the internal combustion engine 26 from this time onward. Thus, according to the embodiment, the malfunction of the negative pressure sensor 52 or the prohibition of the automatic stop of the internal combustion engine 26, based on the malfunction of the negative pressure sensor 52, is promptly notified to the driver by the MIL 60 during the malfunction condition of the negative pressure sensor 52. Therefore, replacement or repair of the negative pressure sensor 52 in the malfunction condition can be promoted.

Moreover, in the embodiment, if it is once determined that the negative pressure sensor 52 is in the malfunction condition and thereafter determined that the negative pressure sensor 52 is in the normal condition, the prohibition of the automatic stop of the internal combustion engine 26 by the S & S control is canceled, and the MIL 60 is turned off. Thus, according to the embodiment, after the negative pressure sensor 52 returns from the malfunction condition to the normal condition, the automatic stop of the internal combustion engine 26 by the S & S control is permitted. Therefore, the fuel efficiency can be improved, and the unnecessary replacement, repair, or the like of the negative pressure sensor 52 can be eliminated.

In the above embodiment, the brake booster 32 may be regarded as a “braking operation support device” of the invention. The specified stop condition may be regarded as a “first condition” of the invention. The specified restart condition may be regarded as a “second condition” of the invention. MIL 60 may be regarded as an “indication device” of the invention.

In the above embodiment, the execution of the S & S control by the ECU 50 may be regarded as an “automatic stop initiation means.” The execution of the processing of step S102 in the routine shown in FIG. 4 by the ECU 50 may be regarded as a “braking operation presence/absence determination means.” The execution of the processing in step S104 by the ECU 50 may be regarded as a “speed detection means.” The execution of the processing in step S108 by the ECU 50 may be regarded as a “negative pressure detection means.” The execution of the processing in step S114 by the ECU 50 may be regarded as an “automatic stop prohibition means.” The execution of the processing in steps S112, S118 by the ECU 50 may be regarded as a “malfunction determination means.” The execution of the processing in step S116 by the ECU 50 may be regarded as a “negative pressure sensor malfunction notification means,” an “automatic stop prohibition notification means,” and a “indication means.”

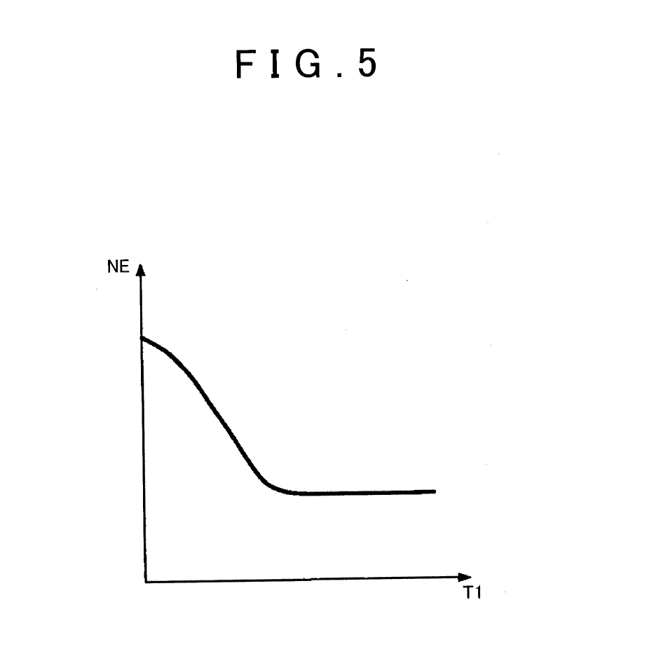

In the above embodiment, the specified threshold NE0 of the speed NE of the internal combustion engine 26 and the specified time period T1 are used to determine whether the rotation condition of the internal combustion engine 26 is satisfied. Each of these specified threshold NE0 and specified time period T1 may be a fixed value. In addition, a negative pressure generation capacity of the direct-acting negative pressure pump 40 changes in response to the speed NE of the internal combustion engine 26. Thus, while the specified threshold NE0 is the fixed value, the specified time period T1 may be changed in response to the speed NE of the internal combustion engine 26 as shown in FIG. 5. According to such a modification, even when the negative pressure generation capacity of the direct-acting negative pressure pump 40 changes, the detection of the negative pressure Pvac for determining whether the negative pressure sensor 52 is in the malfunction condition can be always initiated at the timing at which the negative pressure generated in the negative pressure chamber 34 reaches the vicinity of zero [kPa]. Thus, it can accurately be determined whether the negative pressure sensor 52 is in the malfunction condition.

In addition, in the above embodiment, the determination on whether the braking operation on the brake pedal 30 by the driver is performed in the above step S102 on the basis of whether the master pressure Pm is lower than the specified value Pm0 or whether the stop lamp switch 58 is in the off state. In the embodiment of the invention, the determination in the above step S102 may be made on the basis of whether an absolute value of the differential pressure between a first value of the master pressure Pm and a second value of the master pressure Pm is lower than a specified value. The first value of the master pressure Pm is a value when the rotation of the internal combustion engine 26 starts, and the second value of the master pressure Pm is a value when the negative pressure Pvac is detected with the negative pressure sensor 52. Alternatively, the determination in the above step S102 may be made on the basis of whether the stop lamp switch 58 is in the off state. In the above configuration, the positive determination is made if the differential pressure absolute value is lower than the specified value or if the stop lamp switch 58 is in the off state. In such a modification, a specified value of the differential pressure absolute value may be set at a maximum value of the above differential pressure at which it is determined that the braking operation on the brake pedal 30 is not performed. In this case, making of such a determination by the ECU 50 may be regarded as the “braking operation presence/absence determination means” and a “brake pedal depressing operation presence/absence determination means.”

In addition, the determination in the above step S102 may be made on the basis of whether differential pressure that is obtained by subtracting the second value of the master pressure Pm from the first value of the master pressure Pm, which are described above, is zero or higher and lower than a specified value. Alternatively, the determination in the above step S102 may be made on the basis of whether the stop lamp switch 58 is in the off state. In this case, a positive determination is made if the differential pressure is zero or higher and lower than the specified value or if the stop lamp switch 58 is in the off state. Noted that, in such a modification, the specified value of the differential pressure has only to be set at a maximum value of the above differential pressure at which it is determined that the braking operation on the brake pedal 30 is not performed. In this case, making of such a determination by the ECU 50 may be regarded as the “braking operation presence/absence determination means” and the “brake pedal depressing operation presence/absence determination means.”

Furthermore, the determination in the above step S102 may be made on the basis of whether the differential pressure that is obtained by subtracting the second value of the master pressure Pm from the first value of the master pressure Pm, which are described above, is a specified value or higher. Alternatively, the determination in the above step S102 may be made on the basis of whether the stop lamp switch 58 is switched from an on state to the off state. In this case, a positive determination is made if the differential pressure is at the specified value or higher, or if the stop lamp switch 58 is switched from the on state to the off state. In this case, making of such a determination by the ECU 50 may be regarded as the “braking operation presence/absence determination means” and the “brake pedal returning operation presence/absence determination means.”

In the above embodiment, the brake system 24 is provided with the direct-acting negative pressure pump 40 that is actuated in response to the rotation of the internal combustion engine 26. Then, the ECU 50 determines whether the rotation condition of the internal combustion engine 26 is satisfied in step S106. However, the invention is not limited thereto and can also be applied to the brake system 24 that is not provided with the direct-acting negative pressure pump 40. In the brake system 24 that is not provided with the direct-acting negative pressure pump 40, the timing at which the sufficient negative pressure is generated in the negative pressure chamber 34 not only depends on the rotation of the internal combustion engine 26 but also depends on an opening degree of a throttle provided in the internal combustion engine 26. Accordingly, the ECU 50 may determine whether the rotation condition of the internal combustion engine 26 is satisfied as will be described below.

More specifically, in such a modification, as shown in a combination of FIGS. 7A and 7B, the ECU 50 reads the master pressure Pm on the basis of the output signal of the master pressure sensor 56 (step S200), and then determines whether the brake pedal returning operation of the brake pedal 30 by the driver is performed (step S202). A negative determination may be made, for example, if a reduced amount of the master pressure Pm is a specified value or lower. Noted that the above specified value may be set at a maximum value of the reduced amount of the master pressure Pm that is generated when the brake pedal returning operation of the brake pedal 30 is not performed.

If the ECU 50 determines in the above step S202 that the brake pedal returning operation of the brake pedal 30 is performed, any processing will not be performed from this time onward, and the current routine is terminated. On the other hand, if the ECU 50 determines that the brake pedal returning operation of the brake pedal 30 is not performed, the ECU 50 next reads the speed NE of the internal combustion engine 26 on the basis of the output signal of the speed sensor 54 (step S204), and then determines whether the rotation condition of the internal combustion engine 26 is satisfied (step S206). A positive determination may be made, for example, when the speed NE of the internal combustion engine 26 is at a specified threshold or higher continuously for a specified time period or longer. The specified threshold in this modification may be the same as the specified threshold NE0 in the above embodiment. The specified time period in this modification may be the same as the specified time period T1 in the above embodiment.

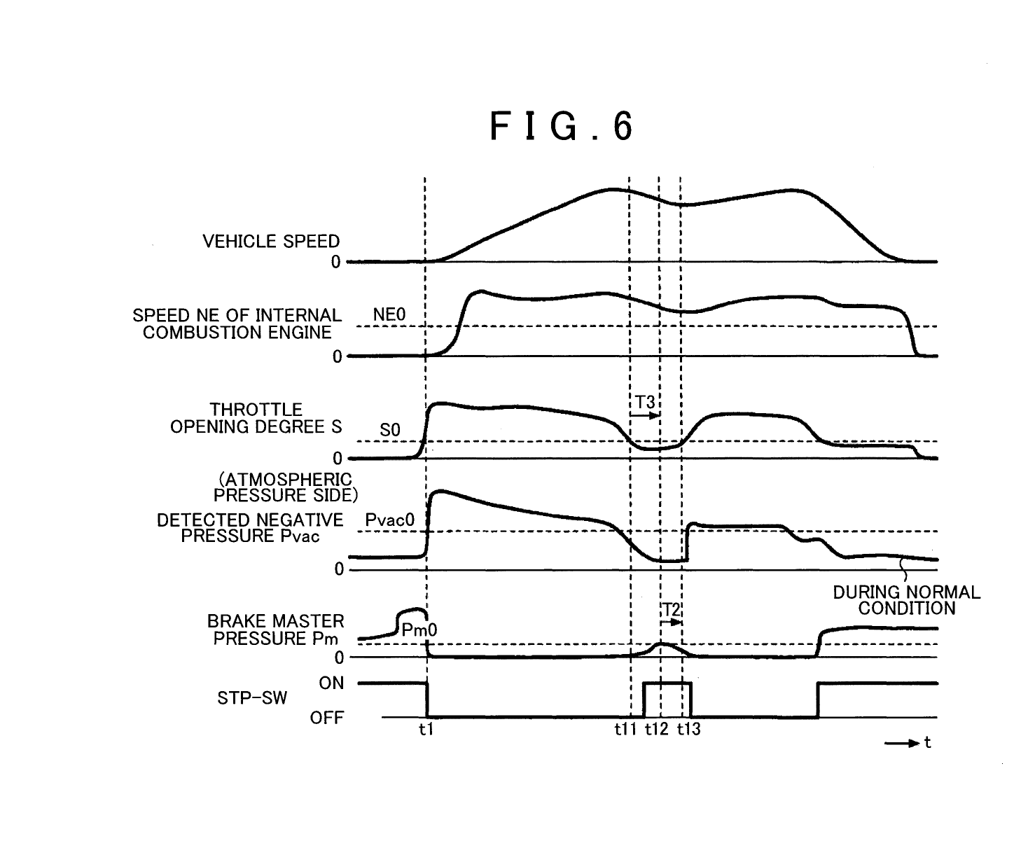

If the ECU 50 determines in the above step S206 that the rotation condition of the internal combustion engine 26 is not satisfied, any processing will not be performed from this time onward, and the current routine is terminated. On the other hand, if the ECU 50 determines that the rotation condition of the internal combustion engine 26 is satisfied, the ECU 50 next reads a throttle opening degree S on the basis of an output signal of a throttle opening degree sensor that outputs a signal corresponding to the opening degree of the throttle provided in the internal combustion engine 26 (step S208). Thereafter, the ECU 50 determines whether a condition for the throttle opening degree S is satisfied (step S210). A positive determination may be made, for example, when the throttle opening degree S is a specified opening degree S0 or lower continuously for a specified time period T3 (the time t1 to t12 in FIG. 6) or longer. The specified opening degree S0 and the specified time period T3 may each be set at a value at which it is determined that the negative pressure in the specified level or higher (specifically, in the vicinity of zero [kPa]) is generated in the negative pressure chamber 34 of the brake booster 32 due to the rotation of the internal combustion engine 26.

If the ECU 50 determines in the above step S210 that the condition for the throttle opening degree S is not satisfied, any processing will not be performed from this time onward, and the current routine is terminated. On the other hand, if the ECU 50 determines that the condition for the throttle opening degree S is satisfied, as shown in the combination of FIGS. 7A and 7B, the same processing as the processing in step S108 onward that is shown in FIG. 4 is executed. The positive determination regarding the negative pressure level may be satisfied in the above step S110 when the negative pressure Pvac is the specified negative pressure Pvac0 or higher continuously for the specified time period T2 (the time t12 to t13 in FIG. 6) or longer. Then, if it is determined that the negative pressure Pvac is the specified negative pressure Pvac0 or higher, it is determined that the negative pressure sensor 52 is in the normal condition. On the other hand, if the negative pressure Pvac is lower than the specified negative pressure Pvac0 and it is thus determined that the negative pressure Pvac is on the atmospheric pressure side with respect to the specified negative pressure Pvac0, it is determined that the negative pressure sensor 52 is in the malfunction condition.

Noted that so-called pumping loss occurs sufficiently at a timing when the brake pedal returning operation of the brake pedal 30 is not performed, the speed NE of the internal combustion engine 26 is at the specified threshold or higher continuously for the specified time period or longer, and the throttle opening degree S is the specified opening degree S0 or lower continuously for the specified time period T3 or longer. Thus, the sufficient negative pressure is generated in the negative pressure chamber 34 of the brake booster 32 in the above timing. Thus, even with a configuration that the brake system 24 is not provided with the direct-acting negative pressure pump 40 as in such a modification, it can be determined, on the basis of the detected negative pressure Pvac at the above timing, whether the negative pressure sensor 52 is in the malfunction condition. Therefore, the same effect as that in the above embodiment can be obtained.

In addition, in the above embodiment, the internal combustion engine 26 and the direct-acting negative pressure pump 40 are connected to the negative pressure chamber 34 of the brake booster 32 via the negative pressure pipe 38, and the negative pressure in response to the rotation of the internal combustion engine 26 is introduced into the negative pressure chamber 34. In the embodiment of the invention, an electric vacuum pump may be connected to the negative pressure chamber 34 via the negative pressure pipe 38, and the negative pressure may be introduced into the negative pressure chamber 34 by actuation of the electric vacuum pump that is actuated with a supply of the electric power regardless of the rotation of the internal combustion engine 26. This electric vacuum pump may be actuated during the actuation of the vehicle 20 including during the S & S control.

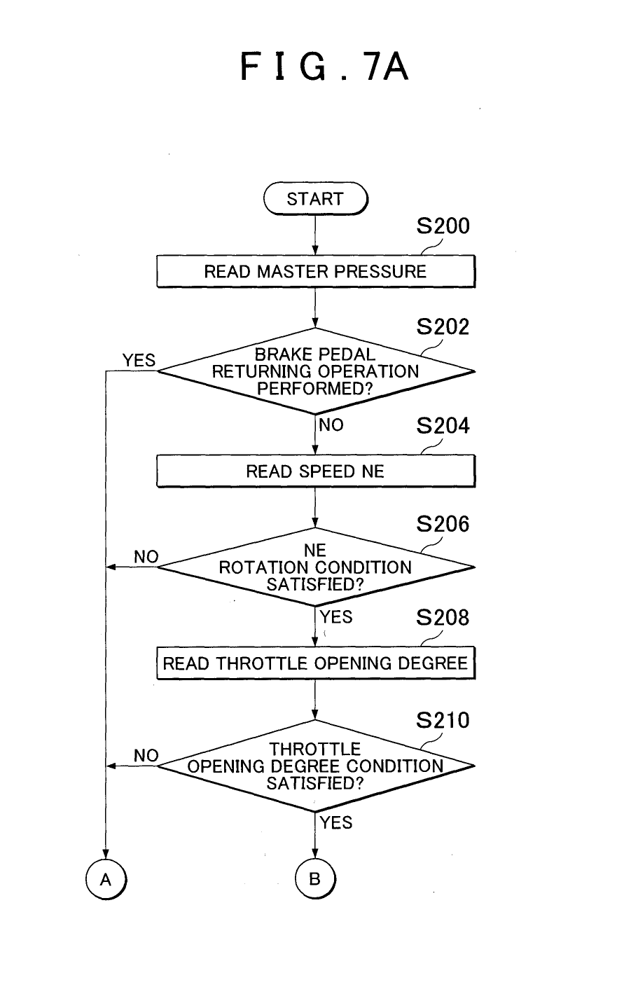

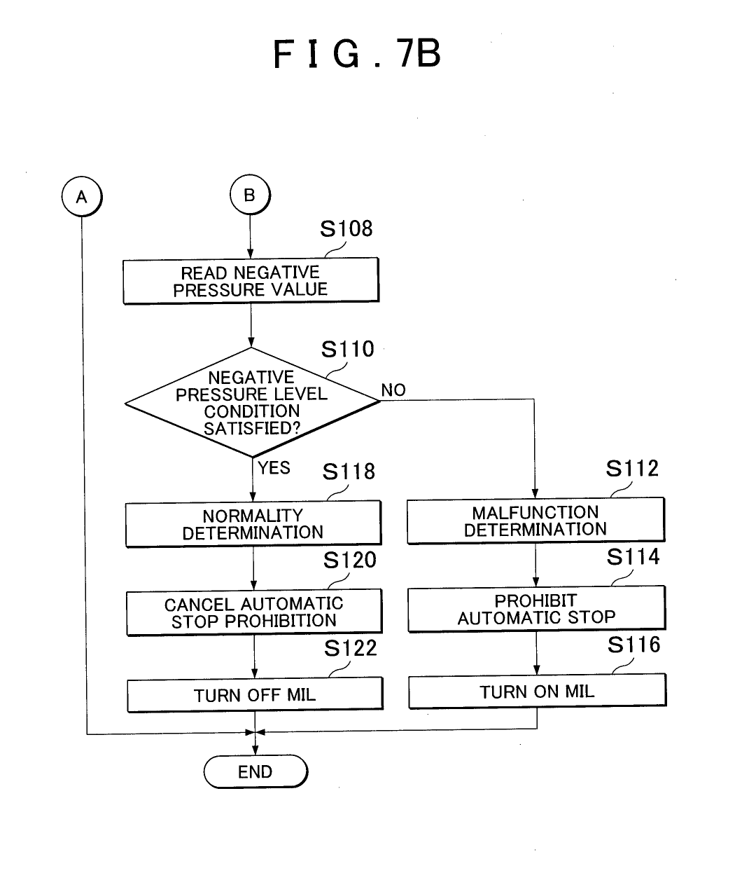

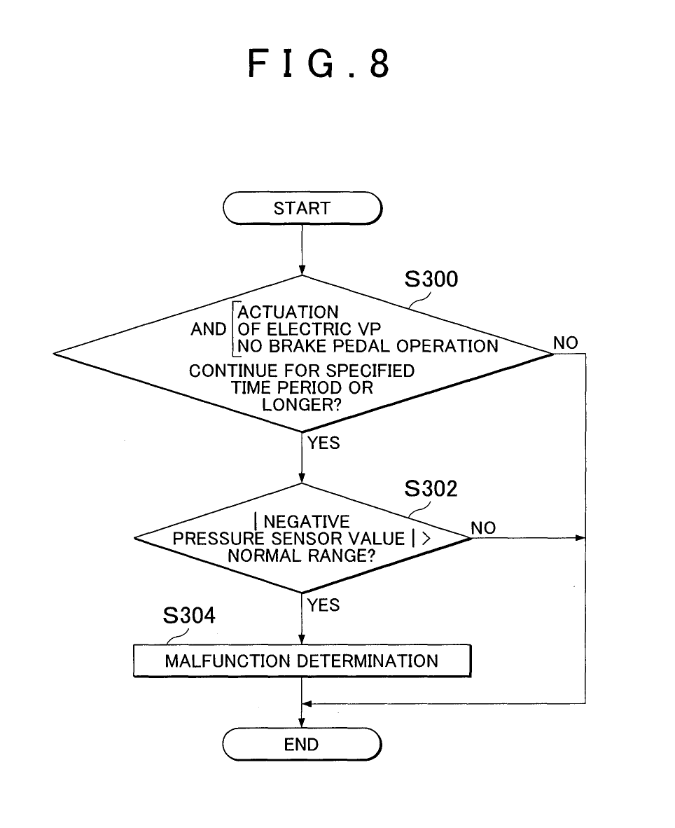

For example, as shown in FIG. 8, the ECU 50 determines whether the braking operation on the brake pedal 30 by the driver is not performed and the electric vacuum pump is actuated continuously for a specified time period or longer (step S300). Noted that this specified time period may be set at a value at which it is determined that the negative pressure in the specified level or higher (specifically, in the vicinity of zero [kPa]) is generated in the negative pressure chamber 34 of the brake booster 32 due to the actuation of the electric vacuum pump. Then, if the ECU 50 determines that the braking operation on the brake pedal 30 is not performed and that the electric vacuum pump is actuated continuously for the specified time period or longer, the ECU 50 next determines whether the negative pressure Pvac of the negative pressure chamber 34, which is detected on the basis of the output signal of the negative pressure sensor 52, falls out of a predetermined normal range (step S302). As a result, if it is determined that the negative pressure Pvac falls out of the normal range, it is determined that the negative pressure sensor 52 is in the malfunction condition (step S304). Noted that the malfunction includes the deviation-malfunction in the negative pressure sensor 52.

At a timing when the braking operation on the brake pedal 30 is not performed, the electric vacuum pump is actuated continuously for the specified time period or longer, and the negative pressure sensor 52 is in the normal condition, the negative pressure Pvac of the negative pressure chamber 34, which is detected with the negative pressure sensor 52, becomes the value on the pressure zero [kPa] side with respect to the specified negative pressure Pvac0. On the other hand, the negative pressure Pvac of the negative pressure chamber 34, which is detected with the negative pressure sensor 52 at the above timing, becomes the value on the atmospheric pressure side with respect to the specified negative pressure Pvac0, if the deviation-malfunction of the negative pressure sensor 52 occurs.

Also in such a modification, it can be determined, in the same manner as the above embodiment, whether the malfunction including the deviation-malfunction occurs in the negative pressure sensor 52. Thus, this occurrence of the deviation-malfunction can promptly be detected as the malfunction of the negative pressure sensor 52 when the deviation-malfunction occurs. In addition, the negative pressure can be introduced into the negative pressure chamber 34 by the actuation of the electric vacuum pump regardless of the rotation of the internal combustion engine 26. Thus, an opportunity to determine whether the malfunction of the negative pressure sensor 52 occurs can be increased. In this way, the occurrence of the malfunction of the negative pressure sensor 52 can also promptly be determined.

In this modification, a determination that the negative pressure sensor 52 is in the malfunction condition may be satisfied when the negative pressure Pvac falls out of the normal range continuously for the specified time period or longer. Also in the above modification, it may be determined, in the same manner as the above embodiment, not only that the negative pressure sensor 52 is in the malfunction condition, but also that the negative pressure sensor 52 is in the normal condition. Furthermore, the determination that the negative pressure sensor 52 is in the malfunction condition may be satisfied when the negative pressure Pvac falls out of the normal range continuously for the specified time period or longer, while determining that the negative pressure sensor 52 is in the normal condition when the negative pressure Pvac falls within the normal range continuously for a specified time period or longer. In such a configuration, if the state that the negative pressure Pvac falls out of the normal range and the state that the negative pressure Pvac falls within the normal range occur alternately before either one of the states continues for the specified time period or longer, the continued time period of the state may be reset, so as to improve determination accuracy or to prevent an erroneous determination.

In the above modification, the electric vacuum pump may intentionally be actuated, and the determination of whether the negative pressure sensor 52 is in the malfunction condition may be made on the basis of the negative pressure Pvac that is detected after a negative pressure level condition is satisfied. In this case, the opportunity to determine whether the negative pressure sensor 52 is in the malfunction condition can forcibly be increased. In this case, the electric vacuum pump is intentionally actuated only when it is predicted that no braking operation on the brake pedal 30 is performed. For example, it is determined that the brake pedal 30 is unlikely to be operated, when the accelerator pedal operation and the vehicle speed are detected, i.e., when the accelerator pedal is depressed and the vehicle is accelerated. In this case, the electric vacuum pump may intentionally be actuated. Meanwhile, an alternator is not actuated and electric power is not generated thereby during the automatic stop of the internal combustion engine 26 by the S & S control. Thus, the electric vacuum pump may not intentionally be actuated in order to suppress electric power consumption. Furthermore, it may be predicted in advance that an execution condition for automatically stopping the internal combustion engine 26 by the S & S control is satisfied on the basis of a vehicle state, such as the vehicle speed and deceleration. Then, the determination of whether the negative pressure sensor 52 is in the malfunction condition may be made by intentionally actuating the electric vacuum pump before the internal combustion engine 26 is automatically stopped.

In the above embodiment, the determination of whether the negative pressure sensor 52 is in the malfunction condition is made on the basis of whether the detected negative pressure Pvac of the negative pressure chamber 34 is the specified negative pressure Pvac0 or higher. At this time, this specified negative pressure Pvac0 may be a fixed value. In addition, the negative pressure generation capacity by the rotation of the internal combustion engine varies in response to the atmospheric pressure in an environment in which the vehicle 20 is located and in response to the negative pressure value that is required to secure the braking force during the automatic stop of the internal combustion engine 26 by the S & S control. Accordingly, the above specified negative pressure Pvac0 may vary in response to the atmospheric pressure and the required negative pressure. According to such a modification, the determination of whether the negative pressure sensor 52 is in the malfunction condition can accurately be made. As a result, the automatic stop of the internal combustion engine 26 by the S & S control can accurately be prohibited. In this case, a change of the specified negative pressure Pvac0 by the ECU 50 may be regarded as a “threshold changing means.”

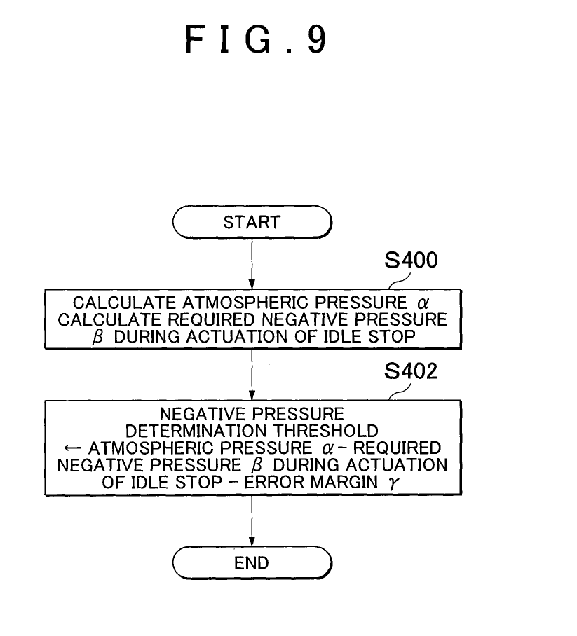

For example, as shown in FIG. 9, when setting the specified negative pressure Pvac0, the ECU 50 first calculates the atmospheric pressure a and also calculates required negative pressure P that is required to secure the braking force to stop the vehicle during the automatic stop of the internal combustion engine 26 by the S & S control (step S400). Then, the specified negative pressure Pvac0 is set on the basis of the thus-calculated atmospheric pressure a and required negative pressure β as well as an error margin γ for absorbing a predetermined characteristic variation error for each of the negative pressure sensor 52 (step S402). More specifically, a value that is obtained by subtracting the required negative pressure β from the atmospheric pressure α and further subtracting the error margin γ therefrom is set as the specified negative pressure Pvac0 (Pvac0=α−β−γ). The ECU 50 executes processing in the above step S110 by using the thus-set specified negative pressure Pvac0.

A predetermined fixed value may be used for the atmospheric pressure α in the above step S400. In addition, while the predetermined fixed value as altitude is used for the atmospheric pressure α, a value that is corrected on the basis of atmospheric pressure information, temperature information, or the like may be used for the altitude fixed value. Furthermore, the atmospheric pressure α may be calculated on the basis of altitude information, the atmospheric pressure information, the temperature information, or the like of a position where the vehicle 20 is currently located.

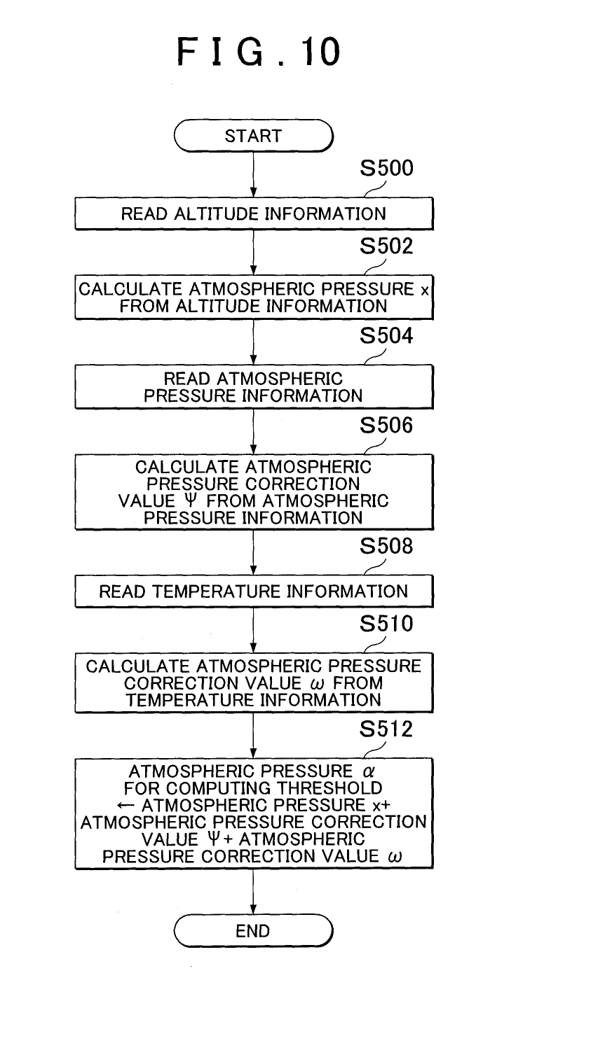

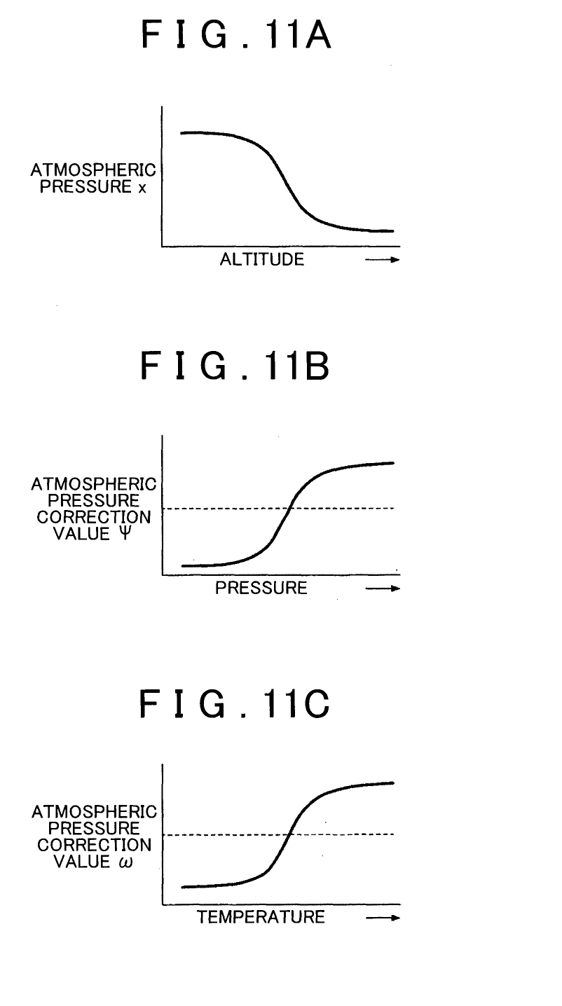

For example, as shown in FIG. 10, when computing the atmospheric pressure α in the above step S400, the ECU 50 first reads the altitude information of the current position where the vehicle 20 travels and that is detected by using a navigation system, an altimeter, or the like (step S500). Then, the ECU 500 refers to a map as shown in FIG. 11A that defines a relationship between predetermined altitude and atmospheric pressure x and calculates the atmospheric pressure x from the read altitude information (step S502). In this case, the atmospheric pressure x is reduced as the altitude is increased, and the atmospheric pressure x is increased as the altitude is reduced.

Next, the ECU 50 reads the atmospheric pressure information of the current position where the vehicle 20 travels by using a weather information terminal, an atmospheric pressure sensor, or the like (step S504). Then, the ECU 500 refers to a map as shown in FIG. 11B that defines a relationship between predetermined atmospheric pressure and an atmospheric pressure correction value ψ and calculates the atmospheric pressure correction value ψ that indicates a difference from a normal value from the read atmospheric pressure information (step S506). In this case, the atmospheric pressure correction value ψ is a value that becomes smaller than the normal value as the atmospheric pressure is reduced and is a value that becomes larger than the normal value as the atmospheric pressure is increased.

Next, the ECU 50 reads the temperature information by using a temperature sensor or the like (step S508). Then, the ECU 50 refers to a map as shown in FIG. 11C that defines a relationship between a predetermined temperature and an atmospheric pressure correction value ω and calculates the atmospheric pressure correction value ω that indicates a difference from the a normal value from the read temperature information (step S510). In this case, the atmospheric pressure correction value ω is a value that becomes smaller than the normal value as the temperature is increased and is a value that becomes larger than the normal value as the temperature is reduced. Then, the ECU 50 calculates the atmospheric pressure α on the basis of the atmospheric pressure x, the atmospheric pressure correction value ψ, and the atmospheric pressure correction value co that are calculated as described above (step S512; α=x+ψ+ω).

A predetermined fixed value may be used for the required negative pressure β in the above step S400. In addition, the required negative pressure β may be calculated by using a negative pressure value that is calculated on the basis of a state that the vehicle 20 is currently located, a surrounding environment, or the like and that is required for braking of the vehicle 20 or a negative pressure value that is calculated on the basis of a characteristic of the vehicle 20 and that is required for braking of the vehicle 20.

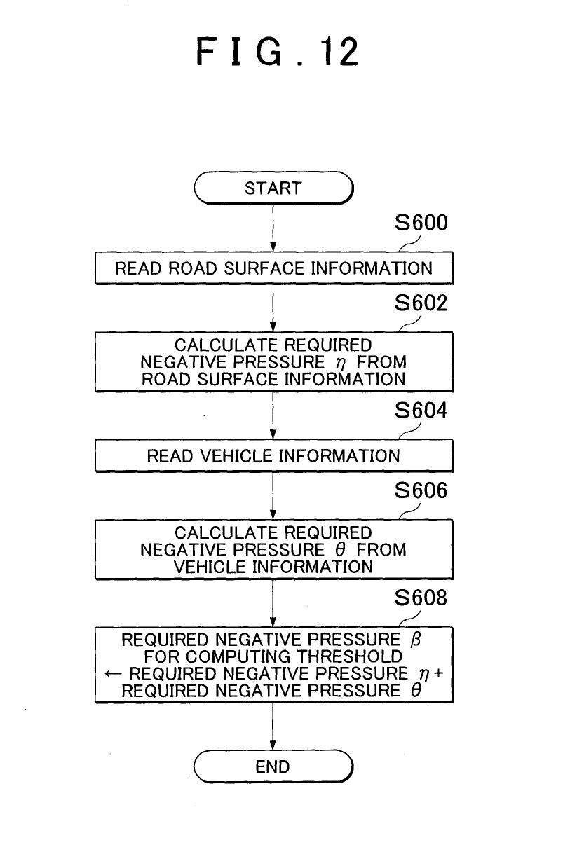

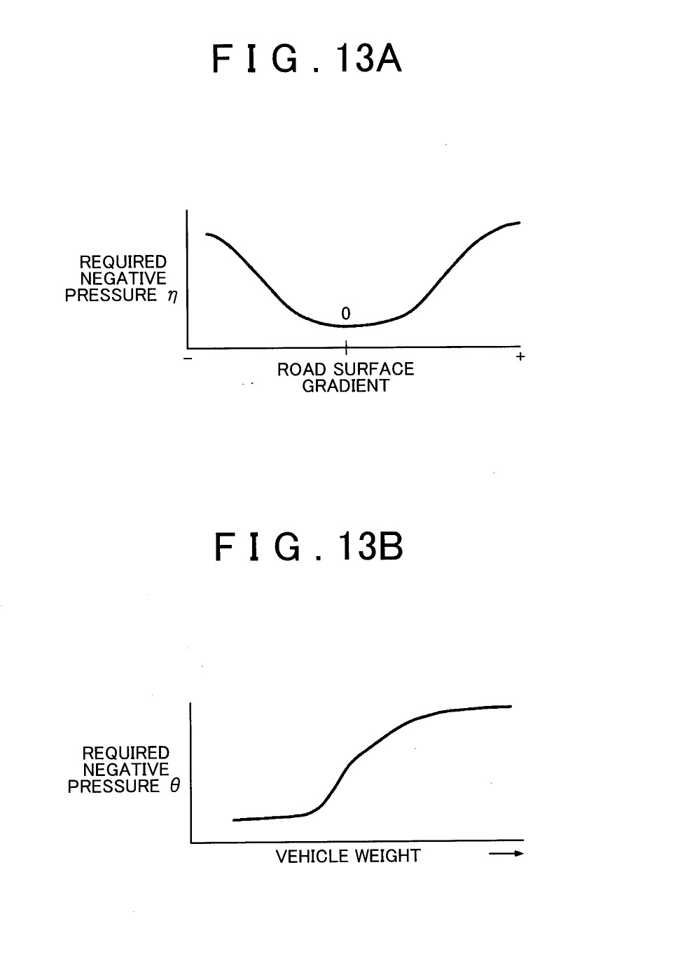

For example, as shown in FIG. 12, when computing the required negative pressure β in the above step S400, the ECU 50 first reads a gradient information of a road surface on which the vehicle 20 is currently located, the information being detected by using the navigation system, a gradient sensor, or the like (step S600). Then, the ECU 50 refers to a map as shown in FIG. 13A that defines a relationship between a predetermined gradient and required negative pressure η and calculates the required negative pressure η from the read gradient information (step S602). In this case, the required negative pressure η is reduced as the gradient becomes close to zero, and is increased as the gradient is increased.

Next, the ECU 50 reads predetermined vehicle information such as a vehicle weight, a vehicle model, displacement of the built-in engine, and the built-in brake system (step S604). Then, the ECU 50 refers to a map as shown in FIG. 13B that defines a relationship between the vehicle information (here, specifically indicates the “vehicle weight”) and required negative pressure θ and calculates the required negative pressure θ from the read vehicle information (step S606). In this case, the required negative pressure θ is reduced as the vehicle weight or the engine displacement is reduced, and is increased as the vehicle weight or the engine displacement is increased. In addition, the ECU 50 then calculates the required negative pressure β on the basis of the calculated negative pressures η, θ as described above (step S608; β=η+θ).

In the above embodiment, the MIL 60, which is the indication lamp provided in the meter, is used as a device configured to indicate to the driver the malfunction of the negative pressure sensor 52 or the prohibition of the automatic stop of the internal combustion engine 26. However, in the embodiment of the invention, another indication device may be used instead of the MIL 60. Alternatively, instead of means by a visual sense, or in addition to the means by the visual sense, means by an auditory sense may be used.

1: A vehicle control apparatus comprising
at least one electronic control unit configured to:
(i) automatically stop an internal combustion engine when a first condition is satisfied;
(ii) automatically stop the internal combustion engine when a second condition is satisfied after the internal combustion engine is automatically stopped;
(iii) determine whether a driver performs a braking operation;
(iv) detect a speed of the internal combustion engine;
(v) detect a negative pressure that is generated in a negative pressure chamber of a braking operation support device; and
(vi) prohibit, based on the detected negative pressure of the negative pressure chamber, the internal combustion engine from automatically stopping when the electronic control unit determines that the driver does not perform the braking operation and that the detected speed of the internal combustion engine is at a threshold or higher continuously for a specified time period or longer, and
a negative pressure sensor configured to output a signal corresponding to the negative pressure generated in the negative pressure chamber, wherein
the negative pressure is generated in the negative pressure chamber in response to rotation of the internal combustion engine,
the braking operation support device is configured to support, with the negative pressure in the negative pressure chamber, the driver to perform the braking operation,
the electronic control unit is configured to detect the negative pressure of the negative pressure chamber based on an output signal of the negative pressure sensor, and
the electronic control unit is configured to determine, based on the detected negative pressure of the negative pressure chamber, whether the negative pressure sensor is in a malfunction condition when the electronic control unit determines that the driver does not perform the braking operation and that the detected speed of the internal combustion engine is at the threshold or higher continuously for the specified time period or longer.

2: The vehicle control apparatus according to claim 1, wherein
the braking operation is a brake pedal depressing operation.

3: The vehicle control apparatus according to claim 1, wherein
the braking operation is a brake pedal returning operation.

4: The vehicle control apparatus according to claim 1, wherein
the electronic control unit is configured to prohibit the internal combustion engine from automatically stopping when the electronic control unit determines that the detected negative pressure of the negative pressure chamber is closer to atmospheric pressure than a specified threshold is.

5. (canceled)

6: The vehicle control apparatus according to claim 1, wherein
the electronic control unit is configured to determine that the negative pressure sensor is in the malfunction condition when the electronic control unit determines that the detected negative pressure of the negative pressure chamber is closer to atmospheric pressure than a specified threshold is.

7: The vehicle control apparatus according to claim 4, wherein
the electronic control unit is configured to calculate the atmospheric pressure based or at least one of a surrounding environment of a host vehicle and host vehicle information,
the electronic control unit is configured to calculate, based on at least one of the surrounding environment and the host vehicle information, a negative pressure to be generated in the negative pressure chamber,
the negative pressure to be generated in the negative pressure chamber is a negative pressure that is required to secure a desired braking force while the internal combustion engine is automatically stopped, and
the electronic control unit is configured to change the specified threshold in response to at least one of the calculated atmospheric pressure and the calculated negative pressure to be generated in the negative pressure chamber.

8: The vehicle control apparatus according to claim 1, wherein
the electronic control unit is configured to notify the driver that the negative pressure sensor is in the malfunction condition when the electronic control unit determines that the negative pressure sensor is in the malfunction condition.

9: The vehicle control apparatus according to claim 8, further comprising
an indication device that is arranged at a position at which the driver can visually recognize the indication device during driving and that is configured to indicate to the driver that the negative pressure sensor is in the malfunction condition, wherein
the electronic control unit is configured to notify, with the indication device, the driver that the negative pressure sensor is in the malfunction condition.

10: The vehicle control apparatus according to claim 1, wherein
the electronic control unit is configured to notify the driver that the internal combustion engine is prohibited from automatically stopping when the electronic control unit prohibits the internal combustion engine from automatically stopping.

11: The vehicle control apparatus according to claim 10, further comprising
an indication device that is arranged at a position at which the driver can visually recognize the indication device during driving and that is configured to indicate to the driver that the internal combustion engine is prohibited from automatically stopping, wherein
the electronic control unit is configured to notify, with the indication device, the driver that the internal combustion engine is prohibited from automatically stopping.
